(19) United States
(12) Patent Application Publication
(10) Pub. No.: US 2002/0015822 A1
(43) Pub. Date: Feb. 7, 2002

(54) High performance imitation leather

(76) Inventors: Ching-Tang Wang, Kaohsiung Hsien (TW); Mong-Ching Lin, Kaohsiung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/885,057

(22) Filed: Jun. 21, 2001

Related U.S. Application Data
(62) Division of application No. 09/598,021, filed on Jun. 21, 2000.

(51) Int. Cl. D04H 3/00; B32B 1/00; D04H 5/00; D06N 7/04

(52) U.S. Cl. 428/151; 428/141; 428/904; 442/327; 442/415

(57) ABSTRACT

A high specific strength, light-weight, low elongation, high peeling strength and burst strength imitation leather with suede hand touch or embossed pattern suitable for manufacturing of gloves, garments, shoes, bags, wallets, couches, seat cover, suitcases, balls and the like, by mixing an adhesion fiber with regular fiber or microfiber to mechanically form nonwoven, then filled with PU composition to become the base material, the surface of the base material is either ground, embossed or bound with a release paper to be coated with PU epoxy composition, or at lease one PU layer with micro-pores is applied on the surface of the base material before the grinding, embossing, or binding.

### BACKGROUND OF THE INVENTION

(a) Field of the Invention

The present invention is related to imitation leather, and more particularly, to a lightweight, low elongation, and both high peeling and burst strength.

(b) Description of the Prior Art

The prior art of synthetic leather for the making of gloves, garments, shoes, seat covers, wallets and the like is essentially comprised of nonwoven made of regular fiber (e.g. polyester fiber) or microfiber (e.g. Polyester/Nylon island-in-the-sea fiber) with the addition of flexible polymer (e.g. polyurethane, PU) as the base material. Efforts to improve appearance hand touch and color display have been focusing on the counts of the fiber with some achievement. However, appearance and hand touch are not sufficient to improve the quality of synthetic leather, high strength and lightweight are also required to facilitate the manufacturing into products.

### SUMMARY OF THE INVENTION

The purpose of the present invention is to provide a high performance, lightweight imitation leather with low elongation, high peeling strength and high burst strength without compromising its appearance or hand touch when compared to the prior art in the making of similar product, e.g. gloves, garments, wallets, couches, seat covers, balls, and the like of the same construction.

The present invention is essentially by mixing adhesive fiber with at least one type of regular or microfiber to form a nonwoven, then filled with polyurethane (PU) composition to form a base material. The base material is ground, or embossed or treated with release paper (or at least, one side of the base material is made a PU layer with micro-pores before the grinding, embossing or lamination process) to form a lightweight, high performance imitation leather with suede surface or the grains seen on a genuine leather.

### BRIEF DESCRIPTION OF THE DRAWINGS

FIG. 1 is a view showing the combination type of nonwoven of the present invention.

### DETAILED DESCRIPTION OF THE PREFERRED EMBODIMENTS

The present invention is essentially made of an nonwoven which is mechanically formed of an adhesive fiber in the form of thermoplastic polyurethane (TPU) or TPU mixed with polypropylene (PP) or polyethylene (PE) or polyamide (NY) or polyester (PTT•PBT•PET) as the effective part to be mixed with an regular fiber or an microfiber.

The nonwoven of the present invention may be prepared by mixing 5˜95% parts by weight of TPU and PP, PE, NY or PTT •PBT•PET), or simply made of 100% PTU. Blending of 5˜45% by weight of adhesive fiber and 95˜55% by weight of regular or microfiber is preferred. The type of the regular fiber or the microfiber is not restricted, with the former could be natural or synthetic fiber, e.g. nylon fiber, polyester fiber and the latter, polyester/nylon island-in-the-sea fiber.

Said nonwoven then is filled with flexible polymer, e.g. PU to form base material for the present invention. At least one side of the base material is made PU layer with a multiple of micro-pores, the surface of said PU layer (or directly on the base material) is ground, embossed or treating with release paper to be coated with PU to give suede hand touch or show grains similar to those seen on genuine leather.

The imitation leather of the present invention is made by the following steps:

(a) prepare the adhesive fiber (2) comprised of TPU and PP, PE, NY or PTT•PBT•PET.

(b) Homogeneously mix the adhesive fiber (2) prepared in Step (1) with at least one type of regular fiber, microfiber in a fiber blending machine, then followed with mechanical processes of carding, stacking and needing to form a solid nonwoven;

(c) Fill PU composition into the nonwoven prepared in Step (b) to form the imitation leather base material.

(d) Grind, emboss or coat PU composition on the surface of the base material prepared in Step

(c) to give it the hand touch or appearance showing similar grains as seen on a genuine leather.

The adhesive fiber prepared in Step (a) may be of 100% TPU. Before proceeding to Step (d), at least one side of the base material prepared in Step (c) may be made a layer of PU with a multiple of micro-pores. Furthermore, the base material availed in Step (c) may be treated with dyeing, water-repelling, anti-bacteria and insect depending on the particular requirements of the finished product.

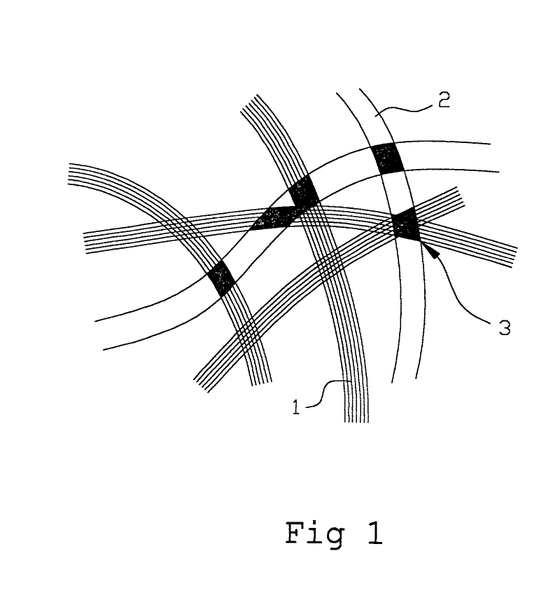

FIG. 1 shows a view of the blended type of the nonwoven. Within, the point (3) where the microfiber (1) crosses the adhesive fiber (2) forms an adhesive point to give the nonwoven both high peeling and burst strength. The adhesive fiber of the present invention constitutes the effective composition of the nonwoven to reduce the consumption of the regular fiber or the microfiber and the flexible polymer (e.g. PU) to achieve the purpose of being lightweight.

The present invention can be further described by those preferred embodiments and comparison examples of the present invention, provided, however, the manufacturing process of the present invention is not restricted by those embodiments and examples.

### Example One

90 parts (90%) of 3 den×5 mm polyester fiber and 10 parts (10%) of 3 den×51 mm adhesive fiber (comprised of 40 parts of TPU and 60 parts of PP) are homogeneously mixed in a fiber blending machine, then carded into web in a carding machine, stacked alternatively into a web stack, and punched into a nonwoven of 180 g/m². The nonwoven is dipped in a bath of solution prepared by 10 parts or duration PU composition and 90 parts of dimethylformamide (DMF) to become an impregnated base material. A solution comprised of 20 parts of duration PU and 80 parts of DMF is applied on either side of said impregnated base material to become a base material for imitation leather with a PU layer after coagulation, water bath, and dehydration. A mono-hydrate PU composition is coated on a separately prepared release paper, followed with another coating of di-hydrate PU composition to form an adhesive layer and bound to the base material. Synthetic leather is formed with grains similar to those on genuine leather after the processes of curing, peeling off and surface treatment. Tests on the synthetic leather indicate lighter, higher peeling and burst strength, and lower elongation when compared to those made of the prior art of the same construction.

### Example Two

85 parts of 4 den×51 mm island type of microfiber and 15 parts of 3 den×51 mm adhesive fiber (comprised of 50 parts each of TPU and NY) are homogeneously mixed in a fiber blending machine, then carded into web in a carding machine, stacked a alternatively into a web stack, and punched into a nonwoven of 300 g/m². The nonwoven is dipped in a bath of solution prepared by 15 parts or duration PU composition and 85 parts of dimethylformamide (DMF) to become an impregnated base material. A solution comprised of 20 parts of duration PU and 80 parts of DMF is applied on either side of said impregnated base material to become a base material for imitation leather with a PU layer after coagulation, water bath, and dehydration. A mono-liquid PU composition is coated on a separately prepared release paper, followed with another coating of dual-liquid PU composition to form an adhesive layer and bound to the base material. Said base material then is reduced to rid of sea composition inherited in the island-in-the-sea type microfiber, followed with water bath, neutralization and dehydration to from base material with microfiber for the making of imitation leather. Synthetic leather of microfiber is formed with grains similar to those on genuine leather after the processes of curing, peeling off and surface treatment. Tests on the synthetic leather indicate lighter, higher peeling and burst strength, and lower elongation when compared to those made of the prior art of the same construction.

### Example Three

The surface of the imitation leather base material of microfiber as prepared in Example Two is ground, followed with dyeing, dehydration and finishing processes to give suede appearance. Tests on the imitation leather indicate advantages of being lighter, higher peeling and burst strength and lower elongation when compared to that made of prior art of the same construction.

### Comparison One

10C parts of 3 den×51 mm polyester fiber is scutched and carded into web, then stacked alternatively and punched into 180 g/m² nonwoven. The nonwoven is dipped in a bath of solution prepared by 10 parts or duration PU composition and 90 parts of dimethylformamide (DMF) to become an impregnated base mater al. A solution comprised of 20 parts of duration PU and 80 parts of DMF is applied on the impregnated base material to become a base material for imitation leather with a PU layer after coagulation, water bath, and dehydration. A mono-liquid PU composition is coated on a separately prepared release paper, followed with another coating of dual-liquid PU composition to form an adhesive layer and bound to the base material. synthetic leather is formed with grains similar to those on genuine leather after the processes of curing, peeling off and surface treatment. Tests on the synthetic leather indicate nothing significantly different from those made of the prior art.

### Comparison Two

100 parts of 4 den×51 mm island type of microfiber is scutched and carded into web, then stacked alternatively and punched into 300 g/m² nonwoven. The nonwoven is dipped in a bath of solution prepared by 15 parts or duration PU composition and 85 parts of dimethylformamide (DMF) to become an impregnated base material containing PU. Said base material then is reduced to rid of sea composition inherited in the island-in-the-sea type microfiber, followed with water bath, neutralization and dehydration to from base material with microfiber for the making of imitation leather. A mono-liquid PU composition is coated on a separately prepared release paper, followed with another coating of dual-liquid PU composition to form an adhesive layer and bound to the base material. Synthetic leather with microfiber is formed with grains similar to those on genuine leather after the processes of curing, peeling off and surface treatment. Tests on the synthetic leather indicate nothing significantly different from those with suede like microfiber made of the prior art.

### Comparison Three

Surface of the base material of imitation leather with microfiber as prepared in Comparison Two is ground, followed with dyeing, dehydration and finishing processes to form synthetic leather with suede like microfiber. Said synthetic leather is tested and the results show that there is no significant difference between the synthetic leather and that made of the prior art.

Tests results by weight, thickness, tensile strength, elongation, peeling strength, burst strength and specific strength on those imitation leather disclosed above in the manufacturing examples and comparisons are listed below. As it shows, given with the same construction, the imitation leather of the present invention is 25% lighter, at least 30% higher in peeling strength, 25% higher in burst strength and 30% lower in elongation.

| | | Example | Example | Example | Comparison | Comparison | Comparison | Test |
|---|---|---|---|---|---|---|---|---|
| | | One | Two | Three | One | Two | Three | Standards |
| Weight (g/m²) | | 350 | 500 | 400 | 420 | 550 | 450 | ASTM D3776 |
| Thickness (mm) | | 1.1 | 1.3 | 1.2 | 1.1 | 1.3 | 1.2 | ASTM D1777 |
| Tensile Strength | MD | 38 | 50 | 45 | 30 | 43 | 38 | ASTM D1117 |
| (kg/2.54 cm) | CD | 35 | 42 | 40 | 26 | 33 | 30 | ASTM D1682 |
| Elongation (%) | MD | 65 | 60 | 60 | 90 | 70 | 70 | |
| | CD | 80 | 95 | 95 | 150 | 120 | 120 | |
| Peeling Strength | MD | 4.5 | 5.3 | | 2.8 | 3.4 | | DIN 53357 |
| (kg/cm) | CD | 4.2 | 6 | | 2.5 | 3.2 | | DIN 53273 |
| Peeling Strength | MD | 4.2 | 5 | | 2.3 | 2.8 | | DIN 53357 |
| After 1/week Dehydration | CD | 4 | 5.4 | | 2.1 | 2.5 | | DIN 53543 |
| Peeling Strength | MD | 3.9 | 4.8 | | 1.6 | 2.2 | | DIN 53357 |
| After 2-week Dehydration | CD | 3.7 | 4.8 | | 1.3 | 2 | | DIN 53543 |
| Burst Strength (kg/cm²) | | 22 | 30 | 26 | 15 | 25 | 20 | ASTM D3786 |
| Specific Strength(burst | | 628571 | 600000 | 650000 | 357143 | 454545 | 444444 | |
| strength/weight) | | | | | | | | |

1. a high strength imitation leather with its base material prepared from a nonwoven filled with PU composes on characterized by that said nonwoven is comprised of an adhesive fiber blended with at least one type of regular fiber or microfiber, and mechanically consolidated; and said adhesive fiber is comprised of TPU alone or a mixture of TPU and PP, PE, NY, PTT, PBT, or PET.

2. The high strength imitation leather as claimed in claim 1, within, containment of said adhesive fiber in the nonwoven is 5˜45% by weight.

3. The high strength imitation leather as claimed in claim 1, within, containment of TPU in the nonwoven is 5˜100% by weight.

4. A manufacturing process for the high strength imitation leather comprised of the following steps:
(a) prepare the adhesive fiber (2) comprised of TPU and PP, PE, NY or PTT•PBT•PET.
(b) Homogeneously mix the adhesive fiber (2) prepared in Step (1) with at least one type of regular fiber, microfiber in a fiber blending machine, then followed with mechanical processes of carding, and stacking to form a solid nonwoven;
(c) Fill PU composition into the nonwoven prepared in Step (b) to form the imitation leather base material.
(d) Grind, emboss or coat PU epoxy composition on the surface of the base material prepared in Step (c) to give it the suede hand touch or appearance showing similar grains as seen on a genuine leather.

5. The manufacturing process for imitation leather as claimed in claim 4, within, at least one side of the base material for the imitation leather formed in Step (c) is made a PU layer with a multiple of micro-pores before proceeding to Step (d).

6. The manufacturing process for imitation leather as claimed in claim 4, within, the base material for the imitation leather formed in Step (c) is processed with dyeing, water-repelling, anti-bacteria and/or insect treatment depending on the particular requirements.

7. The manufacturing process for imitation leather as claimed in claim 4, within, the adhesive fiber prepared in Step (a) can be made of 100% TPU.

8. The manufacturing process for imitation leather as claimed in claim 4, within, containment of the adhesive fiber of the nonwoven is 5˜45% by weight.

9. The manufacturing process for imitation leather as claimed in claim 4, within, containment of the TPU of the adhesive fiber is 5˜100% by weight.
